(19) United States
(12) Patent Application Publication
(10) Pub. No.: US 2006/0168105 A1
(43) Pub. Date: Jul. 27, 2006

(54) Method for updating the local management system in at least one network element of a telecommunication network

(76) Inventors: Jens Glufke, Eglharting (DE); Gunter Hermann, Germering (DE); Claudia Pohle, Munchen (DE); Thomas Rave, Wetzlar (DE)

Correspondence Address: Siemens Corporation;Intellectual Property Department, 170 Wood Avenue South, Iselin, NJ, 08830, US

(21) Appl. No.: 10/529,404

(22) PCT Filed: Sep. 22, 2003
(86) PCT No.: PCT/DE03/03140

§ 371 Date: Dec. 20, 2005

(30) Foreign Application Priority Data
Sep. 30, 2002 (DE) 102 45 641.0

(51) Int. Cl. G06F 15/16

(52) U.S. Cl. 709/218

(57) ABSTRACT

The aim of the invention is to update a local management system in at least one network element of a telecommunication network, said local management system consisting of at least one network element agent stored in a management unit of the network element, and a network element manager. To this end, an updated network element agent and an updated network element manager are directly produced by a common generation mechanism from a pre-determined management interface specification. At least the updated network element agent is then loaded into the management unit of the network element to be updated.

### CROSS REFERENCE TO RELATED APPLICATIONS

This application is the US National Stage of International Application No. PCT/DE03/003140, filed Sep. 22, 2003 and claims the benefit thereof. The International Application claims the benefits of German application No. 10245641.0 DE filed Sep. 30, 2002, both of the applications are incorporated by reference herein in their entirety.

### FIELD OF INVENTION

The invention relates to a method for updating the local management system in at least one network element of a telecommunication network, wherein the local management system consists of at least a network element agent, which is stored in a network element management unit of the network element, and a network element manager.

### BACKGROUND OF INVENTION

A multiplicity of data connections are set up, maintained and cleared down again via a plurality of interconnected network elements (NE). In this context, the network elements have the task of switching or establishing and administrating data connections. In telecommunication networks of this type, the control of the relevant network elements can be carried out via individual local management systems which are integrated in the network elements. Such a local management system is normally made up of two interacting management system modules, namely the network element agents and the network element managers.

The network element agent is integrated in a network element management unit within the network element which has to be managed, and manages individual management objects. Such management objects can contain information about the structure or the architecture of the network element, for example, or about the switching status of the relevant network element or of the telecommunication network. The network element agents also monitor and control these management objects—see the patent document U.S. Pat. No. 5,651,006, columns 1 to 3 concerning this, for example.

The network element manager manages and controls in particular the network element resources which are assigned to a network element agent. For this, the network element manager is connected to the network element agent via a data connection, wherein the exchange of the management data takes place via different network management protocols.

Two international network management standards, among others, are known in this context for telecommunication networks, namely the Bellcore (now Telcordia) management standard and the OSI (Open System Interconnection) management standard. Network management protocols and management interface specifications such as TL1 (Transactions Language 1) or Q3, for example, are derived from these management standards.

Such management interface specifications are subject to continuous changes, which result in updates in the already existing local management system modules, i.e. both in the network element agents and in the network element managers. Following the update of these local management system modules in the relevant network elements, incompatibilities can arise between the network element agent and the network element manager when the local management system is activated. Possible instances of conflict can arise because the network element agent does not recognize and therefore does not execute individual control commands of the network element manager, or because the true operating statuses of the network element are not correctly captured and reported by the updated network element agents.

Until now, updates of the two local management system modules have been performed independently and manually on the basis of the management interface specification which is present in ASCII code, i.e. the machine-readable code of the local management system modules is adapted to the changes individually by a network management specialist. After the individual updating of the two local management system modules is complete, the interaction between the two local management system modules is verified with the aid of system tests. This activity aims to demonstrate that the network element manager covers exactly the instruction set which is required in order to control the network element correctly. Following completion of the system tests, at least the network element agent or both local management system modules are loaded into the relevant network element via a data connection by means of customary instructions for software download.

Furthermore, the patent document U.S. Pat. No. 6,263,366 discloses a system and a method for translating TL1 messages, using a “mapper/parser” module, into messages or control commands which can be processed by the network management system. Using this “mapper/parser” module, the TL1 messages are automatically converted into equivalent alarm reports or equivalent event reports which can be further processed by the network management system.

### SUMMARY OF INVENTION

The present invention addresses in particular the problem of specifying a novel method for updating a local management system in a network element, whereby incompatibilities between the updated network element agent and the updated network element manager can be avoided.

The problem is solved by the features in the independent claims.

The essential advantage of the method according to the invention is that an updated network element agent and an updated network element manager are created by a shared generation mechanism directly from a predetermined management interface specification, and at least the updated network element agent is loaded into the network element management unit of the network element which has to be updated. As a result of the claimed automatic and joint generation of the network element agent and the network element manager directly from the present management interface specification, compatibility between the two local management system modules is guaranteed, thereby significantly reducing the error susceptibility of the local management system which has to be updated. In addition, the time which is required to activate the local management system following the update is clearly reduced as a result of this.

It is particularly advantageous that the updated network element manager is stored in a central unit of the telecommunication network or is also loaded into the network element management unit of the network element which has to be updated.

It is also advantageous that the updated network element agent and the updated network element manager are loaded via a data connection, using a data transmission protocol, from a user computer into the network element management unit of the network element which has to be updated. This has the result that the loading of the updated local management system modules into the network element which has to be updated can take place automatically and without being geographically dependent.

The invention provides a further advantage in that an HTML management interface specification is additionally created by the shared generation mechanism in the hypertext markup language (HTML) format, and is stored together with the updated network element manager. Such an HTML management interface specification which is present in HTML format can be retrieved easily, and in its updated form, via a Web browser. As a result of this, only those functionalities of the local management system which are currently available for the relevant network element are shown.

Advantageous developments of the claimed method are described in the further patent claims.

### BRIEF DESCRIPTION OF THE DRAWING

FIG. 1—an exemplary embodiment of the method for updating a local management system in a telecommunication network element

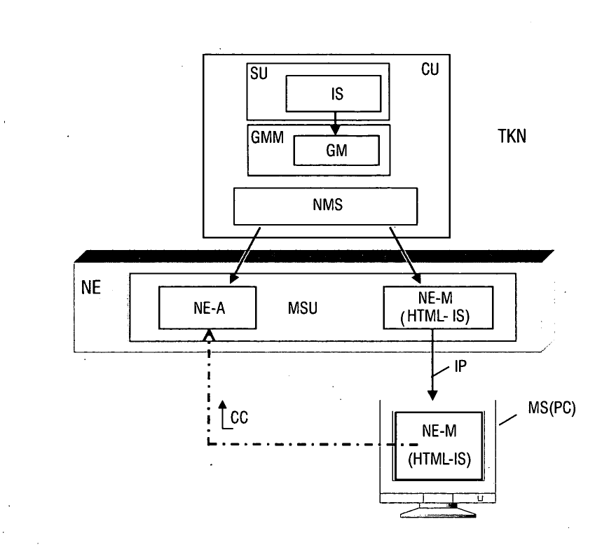

### DETAILED DESCRIPTION OF INVENTION

The method according to the invention is explained in greater detail below with reference to an exemplary embodiment. For this purpose, an exemplary embodiment of the method for updating a local management system MS in at least one network element NE of a telecommunication network TKN is explained with reference to a schematic block diagram. The block diagram exemplifies a central unit CU, e.g. a central server unit, belonging to a telecommunication network TKN, and one of a multiplicity of network elements NE which are present in the telecommunication network TKN. The network element NE has a network element management unit MSU, in which e.g. a network element agent NE-A and a network element manager NE-M are stored. The storage of the two local management system modules NE-A, NE-M can optionally also take place in separate units within the network element NE. The network element NE can be connected to the central unit CU of the telecommunication network TKN via a data connection.

The central unit CU has at least one storage unit SU, in which the current management interface specification IS is stored, preferably in the ASCII code. According to the invention, it is also possible to store different versions or only parts of the management interface specification IS. Provision is also made for the central unit CU to include a generating mechanism module GMM, in which is implemented the shared generating mechanism GM for directly generating the updated network element agent NE-A and the updated network element manager NE-M from the stored management interface specification IS. The shared generating mechanism GM is implemented at least partly by means of a parser in this context.

Provision is also made for the central unit CU to include a central network management system unit, for example, with the assistance of which the complete network management can be carried out centrally within the telecommunication network TKN.

In order to update the local management system MS of the one network element NE, the updated management interface specification IS, which is present in the ASCII data format, e.g. a Tl-1 interface specification, is loaded into the storage unit SU of the central unit CU. In the shared generating mechanism module GMM, which is connected to the storage unit SU via a data connection, the network element agent NE-A and the network element manager NE-M are directly generated as machine-readable code from the management interface specification IS which is present in ASCII code. Alternatively, this generation can be carried out in a separate unit—not shown in the figure—separately from the central unit CU of the telecommunication network TKN. The updated network element agent NE-A and the updated network element manager NE-M are then loaded directly into the network element management unit MSU of the network element NE which has to be updated, via a data connection or via a data interface of the central network management system NMS, wherein the network element manager NE-M can be “downloadably” stored alternatively in a central storage unit SU of the telecommunication network TKN or in a storage unit of a portable user computer PC.

The updated network element agent NE-A is alternatively loaded via a data connection using a data transmission protocol, e.g. the File Transfer Protocol (FTP), from a portable user computer PC into the network element NE which has to be updated or into the network element management unit MSU thereof.

In order to load the network element manager NE-M from the updated network element NE or a central storage unit, the updated network element manager NE-M is implemented as a JAVA applet, for example. As a result, the “downloading” of the network element manager NE-M can be carried out via the Internet data transmission protocol IP. Such a “download” is possible via any standard user computer PC which has a Web browser, and therefore the management of the updated network element NE, using the network element manager NE-M which is loaded onto the user computer PC, can be carried out geographically remotely from the network element NE that has to be managed. In this type of configuration, the JAVA applet is executed on the Web browser of the user computer PC. A data connection to the updated network element agent NE-A is then established via the network element manager NE-M which is executed in the Web browser, and control commands cc which are generated by the network element manager NE-M are transmitted directly, via the implemented network management protocol e.g. the Tl-1 interface protocol, to the network element agents NE-A which are executed in the network element management unit MSU. In the network element NE, the network element agent NE-A executes the received control commands cc, e.g. TL-1 control commands cc, whereby the actions which are assigned to the control commands cc are initiated in the network element NE.

In addition, an HTML management interface specification HTML-IS in the hypertext markup language format (HTML) is generated directly from the management interface specification IS, which is present in ASCII code, by the generating mechanism GM in the generating mechanism module GMM. This HTML management interface specification HTML-IS is “downloadably” stored, together with the updated network element manager NE-M, either directly in the network element NE which has to be updated or in a central storage unit of the telecommunication network TKN. Using such an HTML management interface specification HTML-IS, which can be displayed by means of a conventional Web browser, a user at a user computer PC can directly request the control commands cc or control options which are available for the relevant network element NE, thereby receiving information about the individual parameter options of the relevant control commands cc which are available. In a preferred embodiment of the invention, the HTML management interface specification HTML-IS and the network element manager NE-M are stored in a shared storage unit.

By virtue of the described method, the compatibility between the network element agent NE-A and the network element manager NE-M is already ensured at an early phase of the updating process, and therefore hardly any conflicts arise within the updated network element NE when the local management system MS is activated after the updating. Such an exact agreement or compatibility of the generated network element manager NE-M with the network element agent NE-A is ensured by virtue of the shared generation, with the assistance of the shared generating mechanism GM, directly from the current management interface specification IS.

In the illustrated exemplary embodiment, only the updating of a single network element NE is described by way of example, and the method according to the invention can alternatively be applied to updating a multiplicity of network elements NE which are present in a telecommunication network TKN.

Moreover, the network element agent NE-A and the network element manager NE-M can be directly generated in the network element NE which must be updated, by virtue of a shared generating mechanism GM which is provided in the relevant network element NE, wherein the current management interface specification IS can be either loaded from a central storage unit SU within the telecommunication network TKN or stored directly in the network element NE which must be updated.

1.-10. (canceled)

11. A method for producing and updating a management system of a telecommunication network element, comprising:
creating a network element agent and a network element manager by a shared generating mechanism from a management interface specification;
updating the management system by storing the created network element agent and network element manager;
exchanging a message between the network element and the network element manager for controlling the network element by the network element manager; and
ensuring that the network element supports the message in accordance with the management interface specification by the network element agent, the network element agent stored in a network element management unit of the network element.

12. The method according to claim 11, wherein the network element manager is stored in a storage unit of a computer.

13. The method according to claim 11, wherein the network element manager is stored in the network element management unit.

14. The method according to claim 11, wherein the network element manager is stored on a central storage unit of the telecommunication network.

15. The method according to claim 11, wherein the network element manager is stored as a JAVA applet.

16. The method according to claim 15, wherein the network element manager is executed in a web browser.

17. The method according to claim 13, wherein the network element manager is loaded from the network element into a computer and the network element subsequently managed remotely from the network element by using the loaded manager.

18. The method according to claim 13, wherein the network element manager is loaded from central storage unit into a user computer and the network element subsequently managed remotely from the network element by using the loaded manager.

19. The method according to claim 11, wherein an HTML management interface specification in the hypertext markup language format is generated by the shared generating mechanism, and is stored with the manager.

20. A production and updating management device, comprising:
a mechanism for creating a network element agent and a network element manager from a management interface specification;
a management system updated by storing the created network element agent and network element manager;
a message that controls the network element by the network element manager exchanged between a telecommunication network element and the network element manager; the network element agent ensuring that the network element supports the message in accordance with the management interface specification; and
a network element management unit of the network element for storing the network element agent.

21. The device according to claim 20, wherein the network element manager is stored in a storage unit of a computer.

22. The device according to claim 20, wherein the network element manager is stored in the network element management unit.

23. The device according to claim 20, wherein the network element manager is stored on a central storage unit of the telecommunication network.

24. The device according to claim 20, wherein the network element manager is stored as a JAVA applet.

25. The device according to claim 20, wherein the network element manager is executed in a web browser.

26. The device according to claim 22, wherein the network element manager is loaded from the network element into a computer and the network element subsequently managed remotely from the network element by using the loaded manager.

27. The device according to claim 22, wherein the network element manager is loaded from central storage unit into a user computer and the network element subsequently managed remotely from the network element by using the loaded manager.

28. The device according to claim 20, wherein an HTML management interface specification in the hypertext markup language format is generated by the shared generating mechanism, and is stored with the manager.

29. A network element manager for controlling a telecommunication network element, comprising:
a control message exchanged between the network element and the network element manager;
a network element agent operatively connected to the manager; and
a management interface specification in a hypertext markup language format generated by a shared generating mechanism.

30. The manager according to claim 29, wherein the network element manager is loaded from the network element into a computer and the network element subsequently managed remotely from the network element by using the loaded manager.

31. The manager according to claim 29, wherein the network element manager is loaded from central storage unit into a user computer and the network element subsequently managed remotely from the network element by using the loaded manager.
